(19) United States
(12) Patent Application Publication
(10) Pub. No.: US 2022/0326590 A1
(43) Pub. Date: Oct. 13, 2022

(54) LASER SHUTTER UNIT AND LASER SYSTEM

(71) Applicant: Panasonic Holdings Corporation, Osaka (JP)

(72) Inventors: SHIGEYUKI MORI, Osaka (JP); IZURU NAKAI, Osaka (JP); TAKAYUKI YOSHIDA, Shiga (JP); TAKAAKI KASSAI, Osaka (JP)

(21) Appl. No.: 17/695,300

(22) Filed: Mar. 15, 2022

(30) Foreign Application Priority Data
Apr. 9, 2021 (JP) 2021-066437

(51) Int. Cl. G02F 1/33; G02F 1/11; H01S 3/106

(52) U.S. Cl. CPC G02F 1/33; G02F 1/11; H01S 3/1068; G02F 2201/34

(57) ABSTRACT

A laser shutter unit includes an acousto-optic element configured to switch an emission direction of incident laser light between a first direction and a second direction, and a multiple reflective optical element configured to reflect first light that is the laser light emitted from the acousto-optic element in the first direction and second light that is the laser light emitted from the acousto-optic element in the second direction, and further reflect at least one of the first light and the second light.

### BACKGROUND

### 1. Technical Field

The present disclosure relates to a laser shutter unit and a laser system.

### 2. Description of the Related Art

Laser shutter units that switch between emitting and blocking a laser include an acousto-optic element (AOM). The acousto-optic element (AOM) has a transmissive acousto-optic crystal (AO crystal). When an ultrasonic wave is applied to the AO crystal, an optical axis of a laser transmitted through the AO crystal changes. That is, the AOM can switch the optical axis of the transmitted laser depending on whether the ultrasonic wave is applied.

A laser shutter unit including the AOM switches an emission direction of an incident laser using this principle, thereby guiding the laser transmitted through the AOM to either outside of the laser shutter unit or a light receiving unit such as a damper. Thus, the laser shutter unit switches between emitting and blocking the laser.

For example, Japanese Patent Unexamined Publication No. 2019-86266 discloses a laser switching device that guides, depending on whether an ultrasonic wave is applied to an AO crystal, laser light transmitted through the AO crystal to either an output unit or a light receiving element that detects the laser light. The laser light guided to the output unit is output to outside of the laser switching device, and the laser light guided to the light receiving element is not output to the outside of the laser switching device.

### SUMMARY

A laser shutter unit according to an aspect of the present disclosure includes an acousto-optic element configured to switch an emission direction of incident laser light between a first direction and a second direction, and a multiple reflective optical element configured to reflect first light that is the laser light emitted from the acousto-optic element in the first direction and second light that is the laser light emitted from the acousto-optic element in the second direction, and further reflect at least one of the first light and the second light.

### BRIEF DESCRIPTION OF THE DRAWINGS

FIG. 1 is a schematic diagram showing a laser system according to a first embodiment of the present disclosure;

FIG. 2 is a diagram showing an operation principle of an acousto-optic element;

FIG. 3 is a diagram showing an example of output waveforms of laser light, a modulation signal, zero-order diffracted light, and first-order diffracted light;

FIG. 4 is a schematic diagram showing a laser system according to a second embodiment of the present disclosure; and

FIG. 5 is a schematic diagram showing a laser system according to a third embodiment of the present disclosure.

### DETAILED DESCRIPTIONS

In the laser switching device according to Japanese Patent Unexamined Publication No. 2019-86266, in order to reliably perform the switching between outputting the laser light to the outside and blocking the laser light, it is necessary to spatially and sufficiently separate an optical axis of the laser light toward the output unit and an optical axis of the laser light toward the light receiving element from each other. For this purpose, it is necessary to ensure a sufficient optical path length of the laser light after passing through the AOM.

When a distance between the AOM and the output unit and a distance between the AOM and the light receiving element are increased, the optical path length of the laser light after transmitting through the AOM is sufficiently ensured, and the laser switching device is increased in size.

An object of the present disclosure is to provide a laser shutter unit and a laser system capable of reducing a size of the shutter unit while increasing reliability of switching between emitting and blocking laser light.

Hereinafter, embodiments and modifications of the present disclosure will be described with reference to the drawings.

### First Embodiment

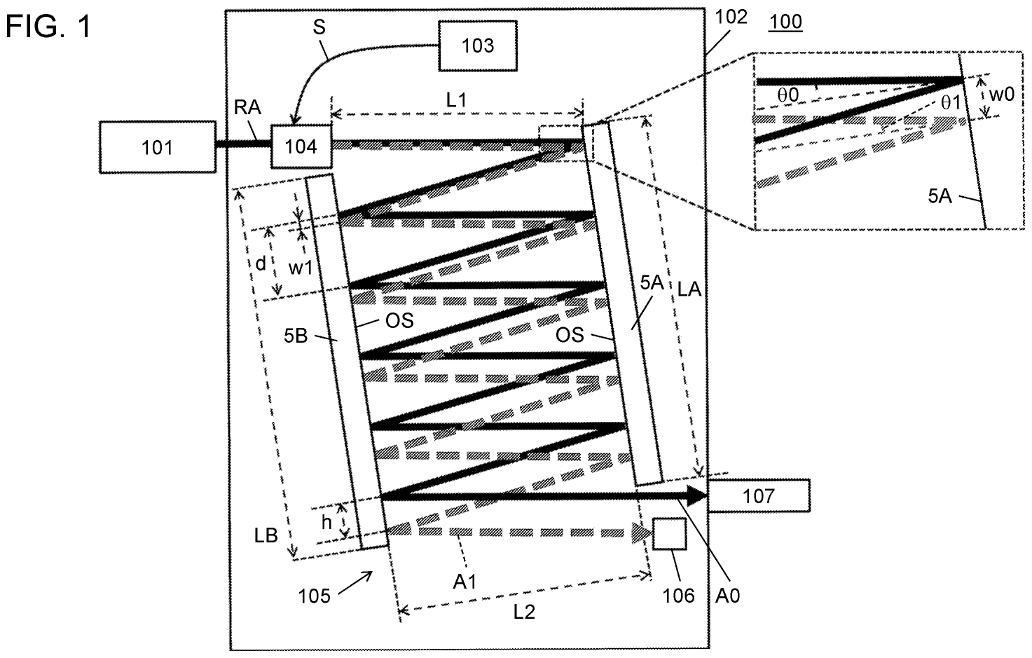

FIG. 1 is a schematic diagram showing laser system 100 according to a first embodiment. Laser system 100 includes laser oscillation unit 101, laser shutter unit 102, light receiving unit 106, and output unit 107.

Laser oscillation unit 101 oscillates laser light RA and outputs laser light RA to laser shutter unit 102. Laser light RA output from laser oscillation unit 101 according to the present embodiment has a single center wavelength and is parallel light.

Laser light RA emitted from laser oscillation unit 101 may not necessarily have a single wavelength, and may have a spread from the center wavelength. Laser light RA emitted from laser oscillation unit 101 may not be completely parallel light. That is, laser light RA may be switchable to zero-order diffracted light A0 and first-order diffracted light A1 by acousto-optic element 104 (described later) of laser shutter unit 102.

Laser oscillation unit 101 includes a laser oscillator that oscillates laser light RA. Laser oscillation unit 101 may include, in addition to the laser oscillator, an optical element such as a lens that guides laser light RA oscillated by the laser oscillator to outside, and an optical fiber such as a transmission fiber.

Laser shutter unit 102 is a switching device that receives laser light RA output from laser oscillation unit 101 and switches between emitting and blocking laser light RA. Laser light output from laser shutter unit 102 can be used for laser processing.

Laser shutter unit 102 includes modulation signal generation unit 103, acousto-optic element (AOM) 104, and multiple reflective optical element 105.

Modulation signal generation unit 103 is a device that generates modulation signal S for modulating an output signal of laser light RA, and is, for example, a pulse generation unit.

AOM 104 is an optical element that switches an emission direction of incident laser light RA.

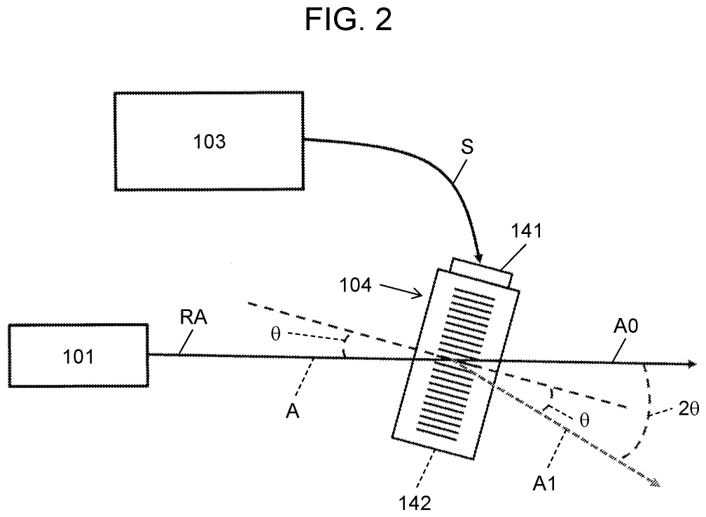

FIG. 2 is a diagram showing an operation principle of AOM 104. AOM 104 includes ultrasonic wave generation unit 141 and AO crystal 142.

Ultrasonic wave generation unit 141 is a device that applies an ultrasonic wave to AO crystal 142 in accordance with modulation signal S from modulation signal generation unit 103. AO crystal 142 is a transmissive acousto-optic crystal, and is a crystal whose refractive index changes when an ultrasonic wave is applied.

AOM 104 is preferably disposed while an orientation thereof is adjusted such that deflection angle θ satisfies following expression (1) using laser center wavelength λ of laser light RA, center frequency fC of an ultrasonic wave generated by ultrasonic wave generation unit 141, and traveling speed V of the ultrasonic wave in AO crystal 142.

$$θ = \frac{λ \cdot fC}{2 V} \qquad ( 1 )$$

In the following description, it is assumed that AOM 104 is disposed such that expression (1) is satisfied.

When ultrasonic wave generation unit 141 is not applying the ultrasonic wave to AO crystal 142, the optical axis of laser light RA is not deflected, and laser light RA is transmitted through AO crystal 142. That is, laser light RA that has laser center wavelength λ and that is incident on AO crystal 142 at deflection angle θ is emitted as zero-order diffracted light A0 in a direction (hereinafter, referred to as a first direction) in which the optical axis of laser light RA does not change.

On the other hand, while ultrasonic wave generation unit 141 is applying the ultrasonic wave to AO crystal 142, laser light RA is deflected by a predetermined angle when laser light RA transmits through AO crystal 142. That is, laser light RA that has laser center wavelength λ and that is incident on AO crystal 142 at deflection angle θ is emitted as first-order diffracted light A1 in a direction (hereinafter, referred to as a second direction) that is shifted from the optical axis of laser light RA by angle 20 (corresponding to twice deflection angle θ).

In this manner, AOM 104 switches incident laser light RA to zero-order diffracted light A0 or first-order diffracted light A1. In other words, AOM 104 receives a laser beam (laser light RA) and selectively orients the laser beam in the first direction or the second direction. AOM 104 selectively emits a first laser beam (zero-order diffracted light A0) that is laser light oriented in the first direction, and a second laser beam (first-order diffracted light A1) that is laser light oriented in the second direction.

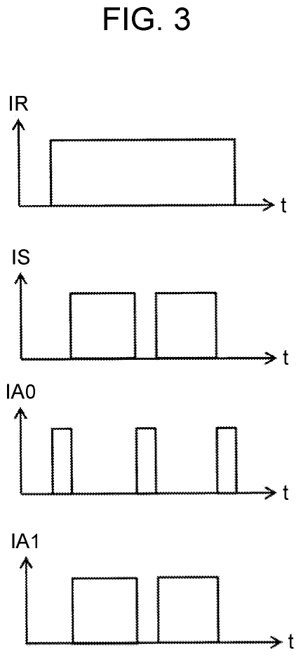

FIG. 3 is a diagram showing an example of output waveforms of laser light RA, modulation signal S, zero-order diffracted light A0, and first-order diffracted light A1.

An uppermost part, a middle upper part, a middle lower part, and a lowermost part in FIG. 3 are waveforms indicating output IR of laser light RA, output IS of modulation signal S, output IA0 of zero-order diffracted light A0, and output IA1 of first-order diffracted light A1, respectively, and a vertical axis and a horizontal axis of each waveform indicate the output and time, respectively.

It is assumed that an output waveform of laser light RA emitted from laser oscillation unit 101 is the waveform shown in the uppermost part of FIG. 3, and an output waveform of modulation signal S output from modulation signal generation unit 103 to AOM 104 is the waveform shown in the middle upper part of FIG. 3.

In this case, as shown in FIG. 3, zero-order diffracted light A0 is output from AOM 104 while laser light RA is being output and modulation signal S is not being output, and first-order diffracted light A1 is output from AOM 104 while laser light RA is being output and modulation signal S is being output.

Modulation signal generation unit 103 may be provided separately from laser shutter unit 102.

The description returns to FIG. 1.

Multiple reflective optical element 105 is an optical element that repeatedly reflects zero-order diffracted light A0 and first-order diffracted light A1 that are emitted from AOM 104, and emits zero-order diffracted light A0 and first-order diffracted light A1 toward output unit 107 and light receiving unit 106, respectively. As shown in FIG. 1, in the present embodiment, multiple reflective optical element 105 emits zero-order diffracted light A0 and first-order diffracted light A1 in the same direction with respect to a position of multiple reflective optical element 105. Multiple reflective optical element 105 will be described in detail later.

Light receiving unit 106 receives first-order diffracted light A1, that is, light that is not used for laser processing. Light receiving unit 106 is, for example, a damper, or a light receiving sensor of a device that measures the output of laser light RA. In the present embodiment, light receiving unit 106 is located on the same side as output unit 107 with respect to the position of multiple reflective optical element 105. For example, as shown in FIG. 1, when output unit 107 is located on a right side of multiple reflective optical element 105, light receiving unit 106 is also located on the right side of multiple reflective optical element 105.

Output unit 107 outputs zero-order diffracted light A0, that is, light used for laser processing to outside of laser shutter unit 102. Output unit 107 is, for example, a condensing optical system, and condenses zero-order diffracted light A0 on a processing optical system outside laser shutter unit 102 or a transmission fiber to be transmitted to the processing optical system.

As shown in FIG. 2, an angle defined by an optical axis of zero-order diffracted light A0 emitted from AOM 104 and an optical axis of first-order diffracted light A1 is 2θ. When expression (1) is satisfied, 2θ is usually about several mrad or more and tens of mrad or less.

That is, 2θ is a fairly small value, and a distance between the optical axis of zero-order diffracted light A0 and the optical axis of first-order diffracted light A1 is fairly short. Accordingly, when light receiving unit 106 and output unit 107 are disposed close to each other, following disadvantages (a) and (b) occur.

(a) Light to be received by light receiving unit 106 is not appropriately received by light receiving unit 106.

(b) Light to be guided to output unit 107 is not appropriately guided to output unit 107.

In order to avoid above disadvantages (a) and (b), it is necessary to dispose light receiving unit 106 and output unit 107 at a relatively long distance from each other. For this purpose, laser shutter unit 102 needs to have a structure in which an optical path of zero-order diffracted light A0 and an optical path of first-order diffracted light A1 are separated from each other by a relatively long distance. That is, it is necessary to sufficiently ensure optical path lengths of zero-order diffracted light A0 and first-order diffracted light A1 from emission from AOM 104 to arrival at output unit 107 or light receiving unit 106.

Laser shutter unit 102 according to the present embodiment includes multiple reflective optical element 105, and multiple reflective optical element 105 can sufficiently ensure the optical path lengths of zero-order diffracted light A0 and first-order diffracted light A1 from the emission from AOM 104 to the arrival at output unit 107 or light receiving unit 106. Hereinafter, multiple reflective optical element 105 will be described in detail.

Multiple reflective optical element 105 includes a pair of mirrors 5A and 5B. The pair of mirrors 5A and 5B are disposed such that reflection surfaces OS of outer surfaces face each other and reflection surfaces OS are parallel to each other.

Zero-order diffracted light A0 emitted from AOM 104 is reflected by mirror 5A and then reflected by mirror 5B. Zero-order diffracted light A0 approaches output unit 107 along mirrors 5A and 5B while being repeatedly reflected by mirror 5A and mirror 5B. After being reflected by mirror 5B, the light is guided to output unit 107.

Similar to zero-order diffracted light A0, first-order diffracted light A1 emitted from AOM 104 is reflected by mirror 5A and then reflected by mirror 5B. First-order diffracted light A1 approaches light receiving unit 106 along mirrors 5A and 5B while being repeatedly reflected by mirror 5A and mirror 5B, and is guided to light receiving unit 106 after being reflected by mirror 5B.

FIG. 1 shows that zero-order diffracted light A0 and first-order diffracted light A1 are reflected by multiple reflective optical element 105 ten times in total (five times in each of mirrors 5A and 5B). A distance between the optical path of zero-order diffracted light A0 and the optical path of first-order diffracted light A1 in a direction along reflection surface OS increases as the number of reflections by multiple reflective optical element 105 increases. In the present embodiment, multiple reflective optical element 105 reflects zero-order diffracted light A0 and first-order diffracted light A1 at least twice.

A reference numeral h in FIG. 1 indicates a distance between a center position of zero-order diffracted light A0 on reflection surface OS when zero-order diffracted light A0 is last reflected and a center position of first-order diffracted light A1 on reflection surface OS when first-order diffracted light A1 is last reflected. Distance h is a reference value of the distance between the optical path of final zero-order diffracted light A0 and the optical path of first-order diffracted light A1.

Distance h is determined to be a desired value according to a beam diameter of laser light RA (that is, beam diameters of zero-order diffracted light A0 and first-order diffracted light A1), a size of light receiving unit 106, and the like. For example, when the beam diameter of laser light RA is 5 mm, distance h may be determined to be 10 mm. The value of 10 mm is based on a fact that, when zero-order diffracted light A0 and first-order diffracted light A1 are radiated on the same plane, it is necessary to ensure a distance of 5 mm between a radiation region of zero-order diffracted light A0 and a radiation region of first-order diffracted light A1, and a fact that for this purpose, it is necessary to ensure a distance of 10 mm between a beam center of zero-order diffracted light A0 and a beam center of first-order diffracted light A1. A purpose that the size of light receiving unit 106 should be considered in determining distance h is to guide first-order diffracted light A1 to light receiving unit 106 and prevent zero-order diffracted light A0 from being radiated to light receiving unit 106.

A disposition position, an orientation, a size, and the like of each component of laser shutter unit 102 are appropriately adjusted such that distance h is a desired value.

In FIG. 1, a reference numeral d indicates an amount of movement of diffracted lights A0 and A1 in the direction along reflection surface OS during a period from when diffracted lights A0 and A1 are reflected by one of mirrors 5A and 5B to when diffracted lights A0 and A1 reach the other mirror again after being reflected by the other mirror.

Amount of movement d preferably satisfies following expression (2).

d=2h (2)

That is, incident angles θ0 and θ1 of zero-order diffracted light A0 and first-order diffracted light A1 with respect to mirror 5A are adjusted such that amount of movement d satisfies expression (2). At this time, an orientation of mirror 5A is mainly adjusted, and accordingly, an orientation of mirror 5B is also adjusted. The larger incident angles θ0 and θ1 are, the larger amount of movement d is.

When amount of movement d satisfies expression (2), incident angles θ0 and θ1 of zero-order diffracted light A0 and first-order diffracted light A1 with respect to mirror 5A preferably satisfy expressions (3) and (4).

$$tan θ 0 = \frac{h}{L 2} \qquad ( 3 )$$

$$θ 1 = θ 0 + 2 θ \qquad ( 4 )$$

In expressions (3) and (4), L1 is a distance from an emission end of zero-order diffracted light A0 in AOM 104 to a center of an arrival position of zero-order diffracted light A0 in mirror 5A, and L2 is a distance between reflection surface OS of mirror 5A and reflection surface OS of mirror 5B.

When incident angles θ0 and θ1 respectively satisfy expressions (3) and (4), distance h is preferably approximated by expression (5). N in expression (5) is the number of times that zero-order diffracted light A0 and first-order diffracted light A1 are reflected by multiple reflective optical element 105, and is a value of two or more.

h=(N−1)·L2·(tan θ1−tan θ0)+L1·tan 2θ (5)

A first item of expression (5) represents a length extended from a first reflection to a last reflection by multiple reflective optical element 105 in the distance between the optical path of zero-order diffracted light A0 and the optical path of first-order diffracted light A1 in the direction along reflection surface OS.

A second item of expression (5) represents an approximate expression of a distance between the center position of zero-order diffracted light A0 and the center position of first-order diffracted light A1 on reflection surface OS when the light is first reflected by multiple reflective optical element 105. Specifically, the second item of expression (5) represents distance w0 in FIG. 1.

When distance h can be approximated by expression (5) and the number of times N is an even number, length LA of mirror 5A and length LB of mirror 5B are preferably approximated by expression (6) and expression (7.1), respectively.

LA=(N−2)·L2·tan θ1+w0+h=(N−2)·L2·tan θ1+L1·tan 2θ+h (6)

LB=(N−2)·L2·tan θ1+w1+h(7.1)

=(N−2)·L2·tan θ1+L1·tan 2θ+L2·tan θ1−L2·tan θ0+h

=(N−1)·L2·tan θ1+L1·tan 2θ (7.2)

L2 tan θ1 of a first item of expression (6) and expression (7.1) represents an amount of movement of first-order diffracted light A1 in the direction along reflection surface OS during a period from when first-order diffracted light A1 is reflected by one of mirrors 5A and 5B to when first-order diffracted light A1 is reflected by the other mirror.

A purpose that a third item (that is, h) is included in expression (6) and expression (7.1) is to ensure a surplus length in consideration of the beam diameters of zero-order diffracted light A0 and first-order diffracted light A1.

A second item of expression (7.1) (see w1 in FIG. 1) represents an approximate expression of a distance between the center position of zero-order diffracted light A0 and the center position of first-order diffracted light A1 on reflection surface OS when the light is reflected by multiple reflective optical element 105 twice.

Expression (7.2) is an expression obtained by modifying expression (7.1) using expression (3).

When expression (5) is satisfied and N is an odd number, length LA of mirror 5A and length LB of mirror 5B are preferably approximated by expression (8) and expression (9.1), respectively.

LA=(N−1)·L2·tan θ1+w0+h=(N−1)·L2·tan θ1+L1·tan 2θ+h (8)

LB=(N−3)·L2·tan θ1+w1+h(9.1)

=(N−3)·L2·tan θ1+L1·tan 2θ+L2·tan θ1−L2·tan θ0+h

=(N−2)·L2·tan θ1+L1·tan 2θ (9.2)

A purpose that a third item (that is, h) is included in expression (8) and expression (9.1) is to ensure the surplus length in consideration of the beam diameters of zero-order diffracted light A0 and first-order diffracted light A1.

Expression (9.2) is an expression obtained by modifying expression (9.1) using 10 expression (3).

As described above, multiple reflective optical element 105 repeatedly reflects zero-order diffracted light A0 and first-order diffracted light A1. Accordingly, it is possible to sufficiently ensure the optical path lengths of zero-order diffracted light A0 and first-order diffracted light A1 from AOM 104 to output unit 107 and light receiving unit 106, respectively. Therefore, since the distance between the optical path of zero-order diffracted light A0 and the optical path of first-order diffracted light A1 when the light is last reflected by multiple reflective optical element 105 is sufficiently long, light receiving unit 106 can be disposed at a relatively long distance from output unit 107. Therefore, zero-order diffracted light A0 can be reliably guided to output unit 107, and first-order diffracted light A1 can be guided to light receiving unit 106. That is, it is possible to improve reliability of switching between emitting and blocking laser light RA by laser shutter unit 102.

Laser shutter unit 102 according to the present embodiment ensures the optical path length from AOM 104 to output unit 107 or light receiving unit 106 by reflecting diffracted lights A0 and A1 plural times. Therefore, it is not necessary to increase the distance between AOM 104 and light receiving unit 106 and the distance between AOM 104 and output unit 107, and it is possible to sufficiently increase the distance between the optical path of zero-order diffracted light A0 and the optical path of first-order diffracted light A1 in a narrow space. Therefore, it is possible to reduce a size of laser shutter unit 102.

Therefore, it is possible to reduce the size of the shutter unit while increasing the reliability of switching between emitting and blocking of the laser light.

Since multiple reflective optical element 105 according to the present embodiment includes the pair of mirrors 5A and 5B disposed such that reflection surfaces OS face each other, diffracted lights A0 and A1 can be reflected to reciprocate between mirror 5A and mirror 5B. Therefore, multiple reflective optical element 105 according to the present embodiment easily reflects diffracted lights A0 and A1 a plurality of times. Therefore, the distance between the optical path of zero-order diffracted light A0 and the optical path of first-order diffracted light A1 is more easily increased.

Since the pair of mirrors 5A and 5B are disposed such that reflection surfaces OS are parallel to each other, the size of laser shutter unit 102 can be easily reduced. Further, it is easy to control traveling directions of zero-order diffracted light A0 and first-order diffracted light A1 and to adjust disposition positions of light receiving unit 106 and output unit 107.

### Second Embodiment

Hereinafter, differences between a second embodiment and the first embodiment will be mainly described.

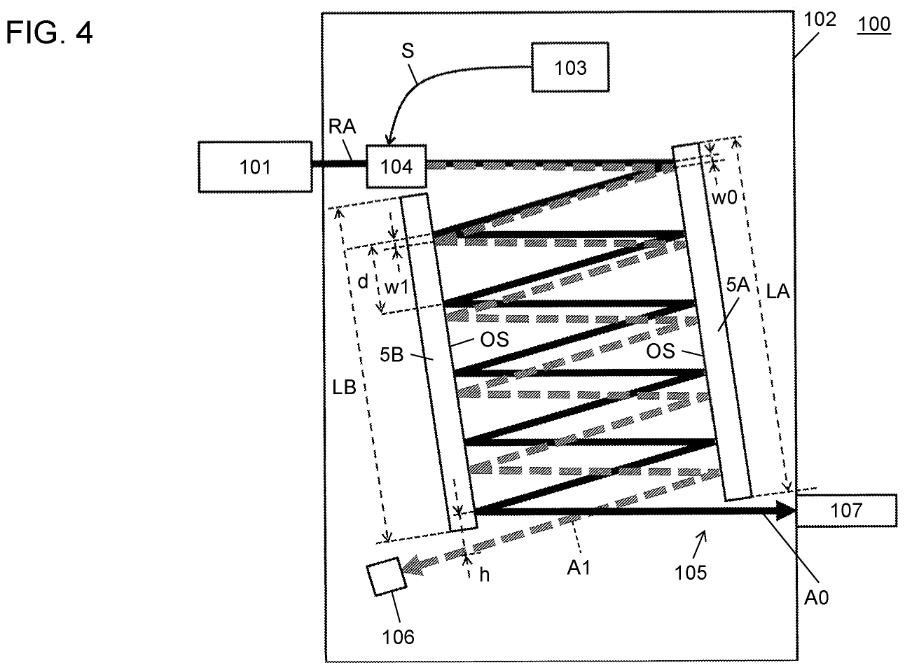

FIG. 4 is a schematic diagram showing laser system 100 according to the second embodiment.

Multiple reflective optical element 105 has a structure in which reflection surface OS that last reflects zero-order diffracted light A0 is different from reflection surface OS that last reflects first-order diffracted light A1. In order to implement this structure, a relative length of mirror 5B with respect to mirror 5A according to the second embodiment is changed with respect to a relative length of mirror 5B with respect to mirror 5A according to the first embodiment. For example, even when length LA of mirror 5A according to the second embodiment is equal to length LA according to mirror 5A of the first embodiment, as shown in FIGS. 1 and 4, length LB of mirror 5B according to the second embodiment is smaller than length LB of mirror 5B according to the first embodiment.

As a result, the number of reflections of zero-order diffracted light A0 by multiple reflective optical element 105 is different from the number of reflections of first-order diffracted light A1 by multiple reflective optical element 105. FIG. 4 shows that zero-order diffracted light A0 is reflected by multiple reflective optical element 105 ten times in total (five times in each of mirrors 5A and 5B), and first-order diffracted light A1 is reflected by multiple reflective optical element 105 nine times in total (five times in mirror 5A and four times in mirror 5B).

As a result, the traveling direction of first-order diffracted light A1 emitted from multiple reflective optical element 105 is opposite to the traveling direction of zero-order diffracted light A0 emitted from multiple reflective optical element 105.

In the present embodiment, the number of reflections N1 of first-order diffracted light A1 by multiple reflective optical element 105 satisfies expression (10) using the number of reflections NO of zero-order diffracted light A0 by multiple reflective optical element 105.

N1=N0−1 (10)

In the present embodiment, the number of reflections NO of zero-order diffracted light A0 by multiple reflective optical element 105 is two or more, and the number of reflections N1 of first-order diffracted light A1 is one or more.

In FIG. 4, reference numeral h indicates a distance between the center position of zero-order diffracted light A0 on reflection surface OS when zero-order diffracted light A0 is last reflected and a center position of first-order diffracted light A1 when first-order diffracted light A1 passes through a surface obtained by extending reflection surface OS after first-order diffracted light A1 is last reflected.

When expressions (2), (3), and (4) are satisfied, distance h can be approximated as in expression (11) using the number of reflections NO of zero-order diffracted light A0 by multiple reflective optical element 105.

h=(N0−1)·L2·(tan θ1−tan θ0)+L1·tan 2θ (11)

When expression (11) is satisfied and NO is an even number, length LA of mirror 5A and length LB of mirror 5B are preferably approximated by expression (12) and expression (13.1), respectively.

LA=(N0−2)·L2·tan θ1+w0+h=(N0−2)·L2·tan θ1+L1·tan 2θ+h (12)

LB=(N0−2)·L2·tan θ0+h(13.1)

=(N0−1)·h (13.2)

L2 tan θ0 in a first item of expression (13.1) represents the amount of movement of first-order diffracted light A1 in the direction along reflection surface OS during the period from when first-order diffracted light A1 is reflected by one of mirrors 5A and 5B to when first-order diffracted light A1 is reflected by the other mirror.

A purpose that the third term (that is, h) is included in expression (12) and a second item (that is, h) is included in expression (13.1) is to ensure the surplus length in consideration of the beam diameters of zero-order diffracted light A0 and first-order diffracted light A1.

As a result of expression (13.1) being modified using expression (3), expression (13.2) is obtained.

When expression (11) is satisfied and NO is an odd number, length LA of mirror 5A and length LB of mirror 5B are preferably approximated by expression (14.1) and expression (15.1), respectively.

LA=(N0−1)·L2·tan θ0+h(14.1)

=N0·h(14.2)

LB=(N0−3)·L2·tan θ1+w1+h(15.1)

=(N0−3)·L2·tan θ1+L1·tan 2θ+L2·tan θ1−L2·tan θ0+h

=(N0−2)·L2·tan θ1+L1·tan 2θ (15.2)

A purpose that a second item (that is, h) is included in expression (14.1) and a third item (that is, h) is included in expression (15.1) is to ensure the surplus length in consideration of the beam diameters of zero-order diffracted light A0 and first-order diffracted light A1.

Expression (14.2) is an expression obtained by modifying expression (14.1) using expression (3). Expression (15.2) is an expression obtained by modifying expression (15.1) using expression (3).

Since the traveling directions of zero-order diffracted light A0 and first-order diffracted light A1 that are emitted from multiple reflective optical element 105 are opposite to each other, a positional relation between light receiving unit 106 and output unit 107 is also different from that according to the first embodiment.

Light receiving unit 106 and output unit 107 are located on two sides of multiple reflective optical element 105. That is, light receiving unit 106 is located on a side opposite to a position of output unit 107 with respect to multiple reflective optical element 105. For example, as shown in FIG. 4, when output unit 107 is located on a right side of multiple reflective optical element 105, light receiving unit 106 is located on a left side of multiple reflective optical element 105.

Multiple reflective optical element 105 according to the present embodiment has a structure in which reflection surface OS that last reflects zero-order diffracted light A0 is different from reflection surface OS that last reflects first-order diffracted light A1. Therefore, the number of reflections of zero-order diffracted light A0 by multiple reflective optical element 105 is different from the number of reflections of first-order diffracted light A1 by multiple reflective optical element 105. Accordingly, it is possible to greatly change the traveling direction of first-order diffracted light A1 emitted from multiple reflective optical element 105 with respect to the traveling direction of zero-order diffracted light A0 emitted from multiple reflective optical element 105.

Therefore, laser shutter unit 102 can more reliably switch between a light guiding destination of zero-order diffracted light A0 and a light guiding destination of first-order diffracted light A1. A degree of freedom in disposing the positions of light receiving unit 106 and output unit 107 is further increased.

### Third Embodiment

Hereinafter, differences between a third embodiment and the second embodiment will be mainly described.

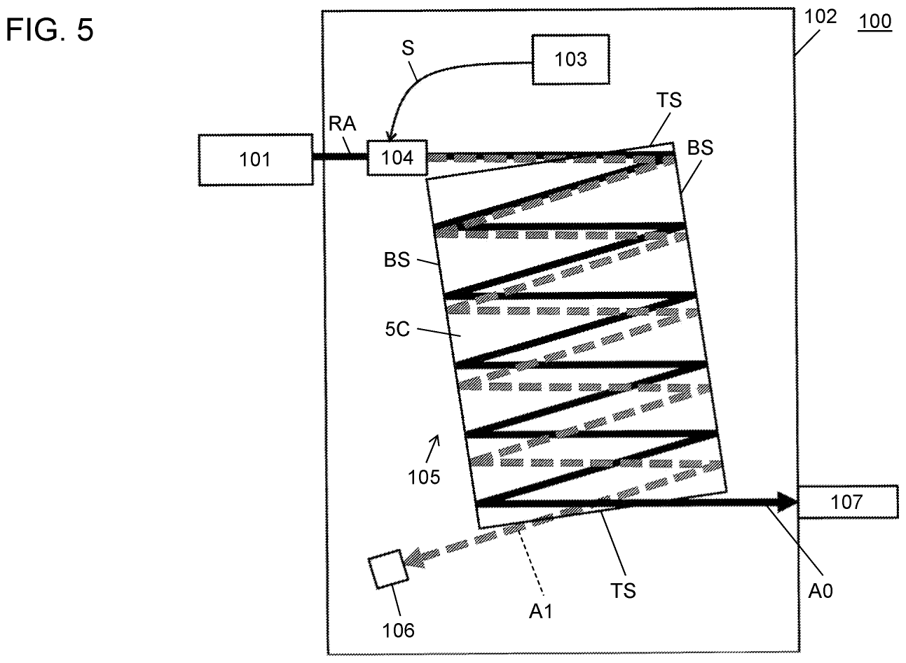

FIG. 5 is a schematic diagram showing laser system 100 according to the third embodiment.

Multiple reflective optical element 105 according to the present embodiment includes prism 5C. Prism 5C has a pair of transmission surfaces TS facing each other and a pair of reflection surfaces BS facing each other. Transmission surface TS is an interface between outside and inside of prism 5C, and is a surface through which zero-order diffracted light A0 and first-order diffracted light A1 transmit. Reflection surface BS is an interface between the outside and the inside of prism 5C, and is a surface that faces the inside of prism 5C and reflects zero-order diffracted light A0 and first-order diffracted light A1. The pair of reflection surfaces BS are parallel to each other. Prism 5C according to the present embodiment has a rectangular parallelepiped shape.

Zero-order diffracted light A0 and first-order diffracted light A1 that are emitted from AOM 104 are incident on prism 5C from one transmission surface TS, and approach the other transmission surface TS while being repeatedly reflected by reflection surfaces BS and BS inside prism 5C. Thus, the distance between the optical path of zero-order diffracted light A0 and the optical path of first-order diffracted light A1 increases. Then, each of zero-order diffracted light A0 and first-order diffracted light A1 is emitted from the other transmission surface TS toward respective output unit 107 and light receiving unit 106 that are located outside prism 5C.

Similar to the second embodiment, prism 5C has a structure in which reflection surface BS that last reflects zero-order diffracted light A0 is a surface different from reflection surface BS that last reflects first-order diffracted light A1. Therefore, as shown in FIG. 5, the number of reflections of zero-order diffracted light A0 by multiple reflective optical element 105 is different from the number of reflections of first-order diffracted light A1. Similar to the second embodiment, in the present embodiment, the number of reflections of zero-order diffracted light A0 is two or more, and the number of reflections of first-order diffracted light A1 is one or more. As a result of the difference between the number of reflections of zero-order diffracted light A0 and the number of reflections of first-order diffracted light A1, the traveling direction of first-order diffracted light A1 is greatly different from the traveling direction of zero-order diffracted light A0 emitted from prism 5C.

Accordingly, light receiving unit 106 and output unit 107 are located on two sides of multiple reflective optical element 105, which is similar to the second embodiment.

Since multiple reflective optical element 105 according to the present embodiment reflects, inside prism 5C, zero-order diffracted light A0 twice or more and reflects first-order diffracted light A1 at least once, one member may be prepared. Therefore, as compared with a case in which multiple reflective optical element 105 includes mirrors 5A and 5B, it is easy to adjust the position and orientation of multiple reflective optical element 105 with respect to each of the optical axes of zero-order diffracted light A0 and first-order diffracted light A1.

Since the pair of reflection surfaces BS of prism 5C face each other, zero-order diffracted light A0 and first-order diffracted light A1 are easily reflected a plurality of times so as to reciprocate between reflection surfaces BS and BS. Therefore, multiple reflective optical element 105 according to the present embodiment easily reflects diffracted lights A0 and A1 a plurality of times, and the distance between the optical path of zero-order diffracted light A0 and the optical path of first-order diffracted light A1 is more easily increased.

Since the pair of reflection surfaces BS of prism 5C are parallel to each other, it is easy to control the traveling directions of zero-order diffracted light A0 and first-order diffracted light A1 and to adjust the disposition positions of light receiving unit 106 and output unit 107.

### Modifications

Multiple reflective optical element 105 may have a structure that reflects zero-order diffracted light A0 twice or more and reflects first-order diffracted light A1 once or more. Hereinafter, modifications of multiple reflective optical element 105 will be described.

Pattern in which Outer Surface is Reflection Surface

When multiple reflective optical element 105 includes the pair of mirrors 5A and 5B facing each other, reflection surfaces OS of mirrors 5A and 5B do not necessarily need to be parallel to each other. If reflection surfaces OS face each other, zero-order diffracted light A0 and first-order diffracted light A1 can be reflected a plurality of times so as to reciprocate between mirror 5A and mirror 5B.

When multiple reflective optical element 105 includes the pair of mirrors 5A and 5B facing each other and zero-order diffracted light A0 and first-order diffracted light A1 may be reflected about twice, reflection surfaces OS may not face each other. For example, mirrors 5A and 5B may be disposed such that reflection surface OS of mirror 5B extends in a vertical direction with respect to reflection surface OS of mirror 5A.

Multiple reflective optical element 105 may include three or more mirrors. For example, multiple reflective optical element 105 may include two mirrors disposed such that reflection surfaces OS face each other and are parallel to each other, and a mirror disposed such that reflection surface OS extends in the vertical direction with respect to reflection surfaces OS of the mirrors.

Mirror 5A may include a plurality of mirrors disposed apart from each other in an extending direction of mirror 5A, and mirror 5B may also be configured in the same manner as mirror 5A.

Multiple reflective optical element 105 does not necessarily include a mirror, and may include, for example, a plurality of reflection members including reflection surface OS that is on an outer surface of multiple reflective optical element 105 and reflects zero-order diffracted light A0 and first-order diffracted light A1. The reflection member is, for example, a prism.

Multiple reflective optical element 105 may include a reflection member that is in a hollow shape and includes a plurality of reflection surfaces OS on the outer surface facing an internal space.

Pattern in which Interface is Reflection Surface

Multiple reflective optical element 105 may have a structure in which reflection surface BS that last reflects zero-order diffracted light A0 and reflection surface BS that last reflects first-order diffracted light A1 are the same surface. That is, multiple reflective optical element 105 may include prism 5C and emit zero-order diffracted light A0 and first-order diffracted light A1 in the same direction with respect to the position of multiple reflective optical element 105.

For example, of reflection surfaces BS and BS of prism 5C according to the third embodiment, reflection surface BS that last reflects zero-order diffracted light A0 may be slightly long. In this case, first-order diffracted light A1 is last reflected by reflection surface BS that is slightly long. Similar to the first embodiment, light receiving unit 106 is located on the same side as output unit 107 with respect to the position of multiple reflective optical element 105. In this case, the number of reflections of zero-order diffracted light A0 is equal to the number of reflections of first-order diffracted light A1.

Two reflection surfaces BS and BS of prism 5C may not be parallel to each other. When two reflection surfaces BS and BS face each other, zero-order diffracted light A0 and first-order diffracted light A1 can be reflected a plurality of times so as to reciprocate between mirror 5A and mirror 5B.

Multiple reflective optical element 105 may have at least transmission surface TS through which zero-order diffracted light A0 and first-order diffracted light A1 transmi, and reflection surface BS that reflects zero-order diffracted light A0 and first-order diffracted light A1.

Therefore, prism 5C may have only one transmission surface TS. For example, prism 5C may have a rectangular parallelepiped shape, and only one surface thereof may be transmission surface TS. Prism 5C may have three or more reflection surfaces BS.

The shape of prism 5C is not limited to the rectangular parallelepiped shape, and may be a cubic shape, a triangular prism shape, a polygonal prism shape such as a quadrangular prism shape having a trapezoidal bottom surface and a quadrangular prism shape having a parallelogram bottom surface, or a polygonal pyramid shape such as a triangular pyramid shape.

In the embodiments and the modifications described above, zero-order diffracted light A0 and first-order diffracted light A1 are guided to output unit 107 and light receiving unit 106, respectively. However, laser system 100 may guide zero-order diffracted light A0 and first-order diffracted light A1 to light receiving unit 106 and output unit 107, respectively.

In the second embodiment and the third embodiment, the number of reflections of zero-order diffracted light A0 is larger than the number of reflections of first-order diffracted light A1. However, the number of reflections of zero-order diffracted light A0 may be smaller than the number of reflections of first-order diffracted light A1. That is, multiple reflective optical element 105 may have a structure that reflects zero-order diffracted light A0 and first-order diffracted light A1 and repeatedly reflects at least one of zero-order diffracted light A0 and first-order diffracted light A1.

According to the present disclosure, it is possible to provide a laser shutter unit and a laser system capable of reducing a size of the shutter unit while increasing reliability of switching between emitting and blocking the laser light.

### INDUSTRIAL UTILIZATION

The present disclosure can be suitably used for a laser shutter unit and a laser system that reduces a size of a shutter unit while increasing reliability of switching between emitting and blocking laser light. The laser shutter unit and the laser system can be applied to a laser apparatus such as a laser processing apparatus or a laser measuring apparatus.

What is claimed is:

1. A laser shutter unit comprising:
an acousto-optic element configured to switch an emission direction of incident laser light between a first direction and a second direction; and
a multiple reflective optical element configured to reflect first light that is the laser light emitted from the acousto-optic element in the first direction and second light that is the laser light emitted from the acousto-optic element in the second direction, and further reflect at least one of the first light and the second light.

2. The laser shutter unit of claim 1, wherein
the multiple reflective optical element includes a plurality of reflection members each having an outer surface that reflects the first light and the second light.

3. The laser shutter unit of claim 2, wherein
the plurality of reflection members are two reflection members, and
the two reflection members are a pair of mirrors disposed such that the outer surfaces of the two reflection members face each other.

4. The laser shutter unit of claim 3, wherein
the two reflection members are disposed such that the outer surfaces of the two reflection members are parallel to each other.

5. The laser shutter unit of claim 1, wherein
the multiple reflective optical element includes an optical element having a transmission surface through which the first light and the second light transmit and an interface that reflects the first light and the second light transmitted through the transmission surface.

6. The laser shutter unit of claim 5, wherein
the optical element is a prism having a pair of the transmission surfaces facing each other and a pair of the interfaces facing each other.

7. The laser shutter unit of claim 6, wherein
the pair of interfaces are parallel to each other.

8. The laser shutter unit of claim 1, wherein
the multiple reflective optical element has a structure in which a surface that last reflects the first light is a surface different from a surface that last reflects the second light.

9. A laser system comprising:
a laser oscillation unit configured to oscillate laser light;
the laser shutter unit of claim 1;
an output unit configured to output the first light to outside of the laser shutter unit; and
a light receiving unit configured to receive the second light, wherein
the laser shutter unit receives the laser light output from the laser oscillation unit.

10. A laser shutter unit comprising:
an acousto-optic element configured to receive a laser beam, selectively orient the laser beam in a first direction or a second direction different from the first direction, and selectively emit a first laser beam that is the laser beam oriented in the first direction and a second laser beam that is the laser beam oriented in the second direction; and
a multiple reflective optical element optically coupled to the acousto-optic element, the multiple reflective optical element being configured to receive the first laser beam and the second laser beam, reflect the first laser beam and the second laser beam, and subsequently further reflect at least one of the first laser beam and the second laser beam.
